(19) United States
(12) Patent Application Publication
(10) Pub. No.: US 2011/0161090 A1
(43) Pub. Date: Jun. 30, 2011

(54) AUTOMATED TICKET PROCESSING SYSTEM AND METHOD

(76) Inventors: Scott K. Tilton, Germantown, TN (US); William Clifford Robinson, JR., Germantown, TN (US); Mark Darty, Collierville, TN (US)

(21) Appl. No.: 12/869,025

(22) Filed: Aug. 26, 2010

Related U.S. Application Data
(60) Provisional application No. 61/237,073, filed on Aug. 26, 2009.

(51) Int. Cl. G06Q 99/00; G01S 13/58; G01P 3/36

(52) U.S. Cl. 705/1.1; 342/104; 356/28

(57) ABSTRACT

A system and method for automating the processing and handling of speeding tickets and similar citations. The system acquires, stores, processes and resolves data associated with the speed detection and video capture of an incident of a vehicle breaking the speed limit. The system includes provisions for data capture, data transfer to an online database, and online plea and payment processing, including online access and electronic notification of the citizen, police and justice department. The invention thereby provides for faster processing, higher efficiency in processing, lower cost to the police and justice departments for processing tickets, and improved accuracy since less human involvement is required.

This application claims benefit of and priority to U.S. Provisional Application No. 61/237,073, filed Aug. 26, 2009, and is entitled to that filing date for priority. The specification, figures and complete disclosure of U.S. Provisional Application No. 61/237,073 are incorporated herein by specific reference for all purposes.

### FIELD OF INVENTION

This invention relates to a system and related method for the automated processing and handling of speeding tickets and similar citations.

### BACKGROUND OF INVENTION

Police officers use radar guns to measure the speed of vehicles for the purpose of documenting a speeding violation. The radar gun is accurate and the speed can be shown to the violating driver for verification. The officer must first measure the violator's speed, then stop the perpetrator, then write a ticket and issue the ticket to the driver. The police officer must enter data onto the ticket regarding the violator's drivers license number, date and time of the offense as well as the location of the offense. Later, if the violator wishes to pay the ticket he/she must mail in the money or go online to pay the ticket. Alternatively, if the violator wishes to contest the violation, then he/she must go to court. All this activity by the police department requires much resource expenditure for processing.

### SUMMARY OF INVENTION

In various exemplary embodiments, the present invention comprises a system and method for automating the processing and handling of speeding tickets and similar citations. One embodiment of the present invention comprises a method to acquire, store, process and resolve data associated with the speed detection and video capture of an incident of a vehicle breaking the speed limit. The system includes provisions for data capture, data transfer to an online database, and online plea and payment processing, including online access and electronic notification of the citizen, police and justice department. The invention thereby provides for faster processing, higher efficiency in processing, lower cost to the police and justice departments for processing tickets, and improved accuracy since less human involvement is required.

Exemplary methods of the present invention may be implemented using a radar gun with video and/or still frame camera capability to record the speed of the violator's vehicle as well as video of the incident; a radar gun with video and/or still frame camera capability that has built in or access to wireless data networks; a radar gun with video and/or still frame camera capability that has built in or access to Global Positioning System (GPS) location information; and a radar gun with video and/or still frame camera capability that has ability to scan a person's drivers license or ID card or the ability to annotate the data with such information at the scene of the speeding violation.

In one exemplary embodiment, a radar speed detection (or laser speed detection) gun in combination with a video and/or still frame camera is used to record the event of a person's vehicle breaking the speed limit. The radar gun is used to measure the speed of the vehicle at a particular time that is noted. A video sequence and/or still frame image associated with the same time the radar gun records the vehicle speed, along with the specific data and time as well as the vehicle speed recorded by the radar gun are all stored in computer memory. Such information may be stored in a relational database.

The GPS location of the incident is added to the database and is related to the incident recorded. The police officer records the vehicle and license plate information along with the driver's identification such as a drivers license number, name, birth date and address of the driver, etc. Additional information can be added to this operation, as might be specifically needed by local law enforcement. The combined information as described above documents the speed of violation, date, time, location, and perpetrator's information. Together this forms the event data that is then uploaded via wireless network to a remote secure database for further processing. The secure database may or may not be owned by law enforcement or justice department officials. The secure database is then available for further processing of the speed violation case.

### BRIEF DESCRIPTION OF THE DRAWINGS

FIG. 1 is a diagram of the components of a system for data capture, transfer, storage and management in accordance with an exemplary embodiment of the present invention.

FIG. 2 is a diagram of an incident data generation and transfer flow process in accordance with an exemplary embodiment of the present invention.

FIG. 3 is a diagram of a web-based data transfer and storage process in accordance with an exemplary embodiment of the present invention.

FIG. 4 is a diagram of a case resolution process in accordance with an exemplary embodiment of the present invention.

FIG. 5 is a log-in page for a system in accordance with an exemplary embodiment of the present invention.

### DETAILED DESCRIPTION OF EXEMPLARY EMBODIMENTS

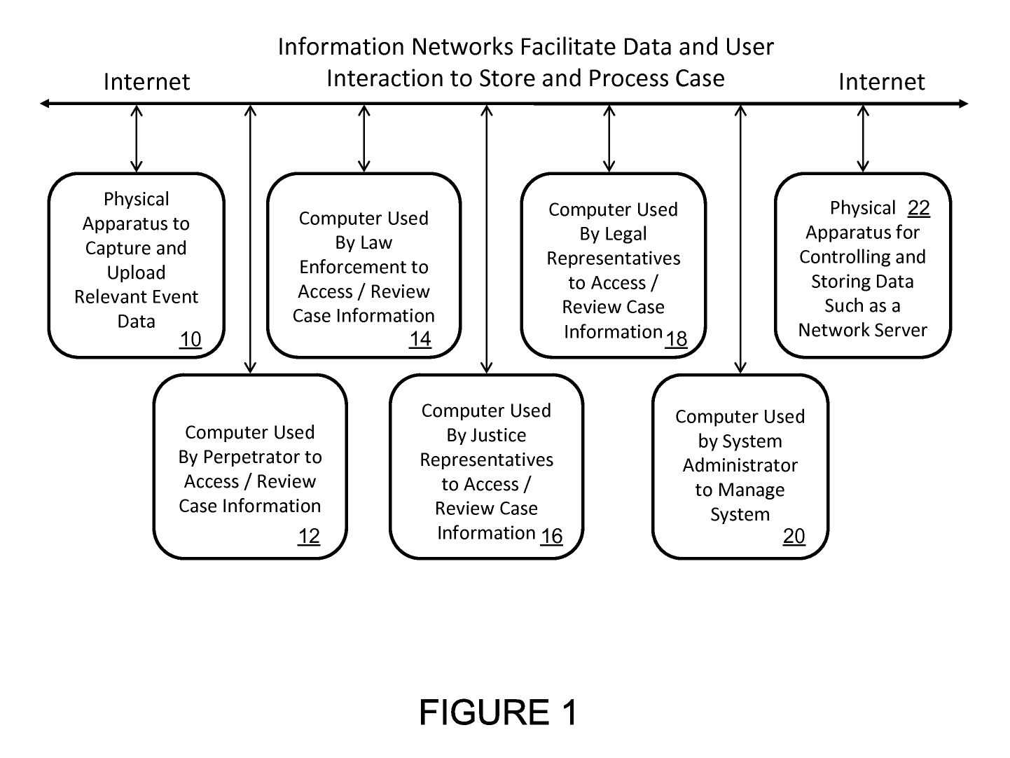

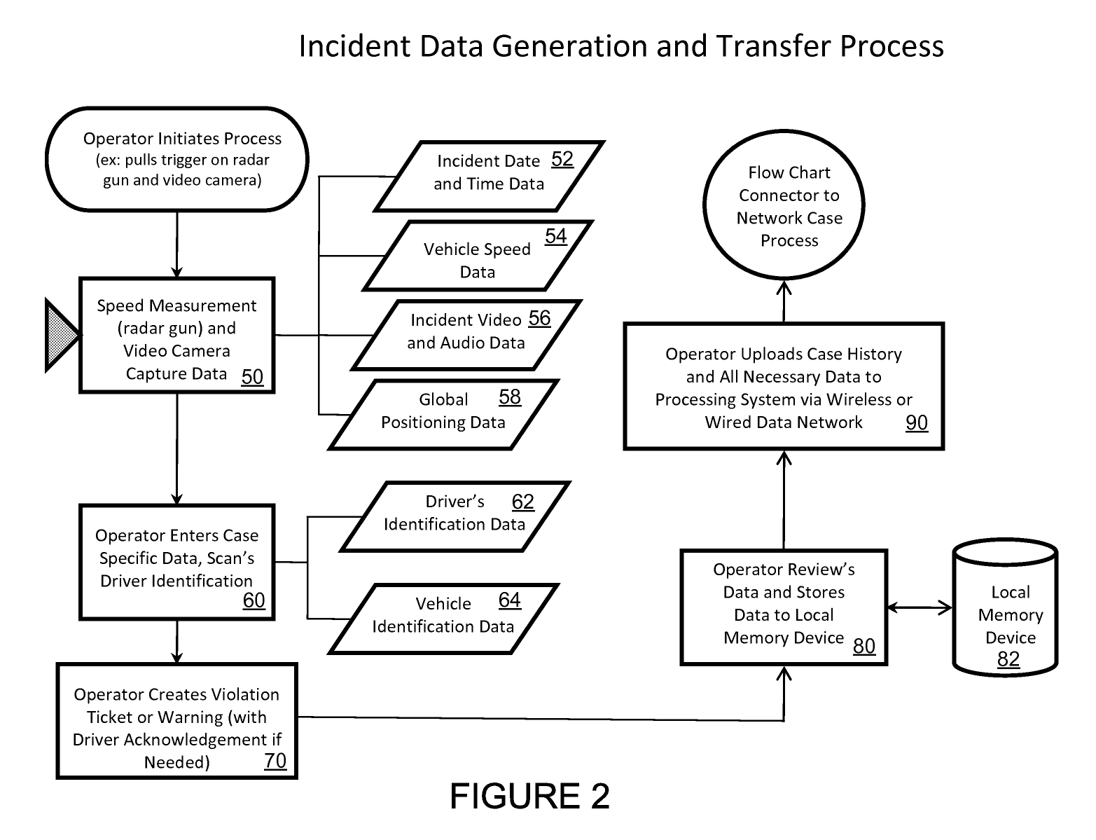

In various exemplary embodiments, as seen in FIGS. 1-5, the present invention comprises a system and method for automating the processing and handling of speeding tickets and similar citations. In particular, one embodiment of the present invention comprises a method to acquire, store, process and resolve data associated with the speed detection and video capture of an incident of a vehicle breaking the speed limit. Users interact with the system using a variety of physical apparatuses and computing devices. The system includes provisions for data capture, data transfer to an online database, and online plea and payment processing, including online access and electronic notification of the citizen, police and justice department. As shown in FIG. 1, for example, a law officer uses a radar or laser gun, or similar apparatus, to capture and upload relevant event data 10 to the system. The perpetrator can use a computing device, such as a personal computer with a web browser or similar software, to access and review the case information 12. Similar computing devices and software can be used by law enforcement personnel 14, justice representatives (including court clerks and judges) 16, and various legal representatives 18 to access and review the case information. A system administrator manages the system 20. The system may comprise a number of computer servers and databases 22.

The invention thereby provides for faster processing, higher efficiency in processing, lower cost to the police and justice departments for processing tickets, and improved accuracy, since less human involvement is required.

The present invention may be implemented using one, more or all of the following components (or similar devices) for capturing and uploading relevant event data 10:

a) a radar gun with video and/or still frame camera capability to record the speed of the violator's vehicle as well as video of the incident;

b) a radar gun with video and/or still frame camera capability that has built in or access to wireless data networks;

c) a radar gun with video and/or still frame camera capability that has built in or access to Global Positioning System (GPS) location information;

d) a radar gun with video and/or still frame camera capability that has ability to scan a person's drivers license or ID card or the ability to annotate the data with such information at the scene of the speeding violation.

An example of a radar gun that can be used for this purpose is disclosed in U.S. Patent Application Pub. No. 20070257814, which is incorporated herein by specific reference for all purposes.

In one embodiment, a radar speed detection (or laser speed detection) gun in combination with a video and/or still frame camera, as described above, is used to record the event of a person's vehicle breaking the speed limit 50. The radar gun is used to measure and record the speed of the vehicle 54 at a particular time. A video sequence and/or still frame image, and possibly audio data, 56 associated with the same time the radar gun records the vehicle speed also is recorded, along with the specific incident date and time 52. This information is all stored in memory in the gun, and/or in a local memory device 82 in a computing device connected to the gun, directly or wirelessly. This information also may be stored in a relational database for longer term storage.

The position of the officer holding the radar gun is recorded from a Global Positioning System (GPS) device, which may or may not be built into the radar/camera system. The GPS data 58 may be stored with the other incident information. This will be referred to herein as the relative location of the traffic incident recorded since the range of the radar/camera system may be limited to the vicinity of the police officer using the radar/camera system. The GPS location of the incident is added to the database and is related to the incident recorded.

The police officer or operator then enters the case specific data and scans or enters the driver identification information 60. This includes recording the vehicle and license plate information 64 along with the driver's identification information 62 such as a drivers license number, name, birth date and address of the driver, and the like. Additional information can be added to this operation, as might be specifically needed by local law enforcement. The officer then creates the citation or ticket or warning 70, with driver acknowledgment, if needed. The officer reviews and stores the data 80 to the local memory device 82, as described above.

The combined information as described above documents the speed of violation, date, time, location, and perpetrator's information. Together this forms the event data that is then uploaded via wireless or wired network 90 to a remote secure database 110 for further processing 120. The secure database may or may not be owned by law enforcement or justice department officials. The secure database 110 is then available for further processing of the speed violation case.

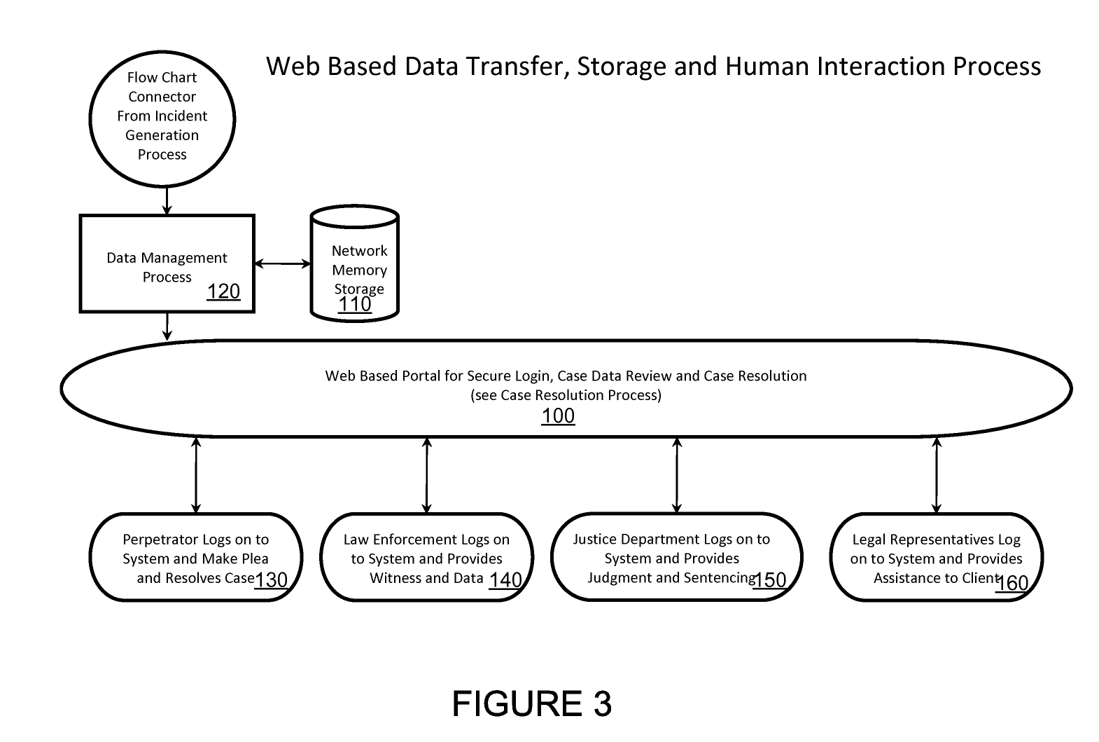

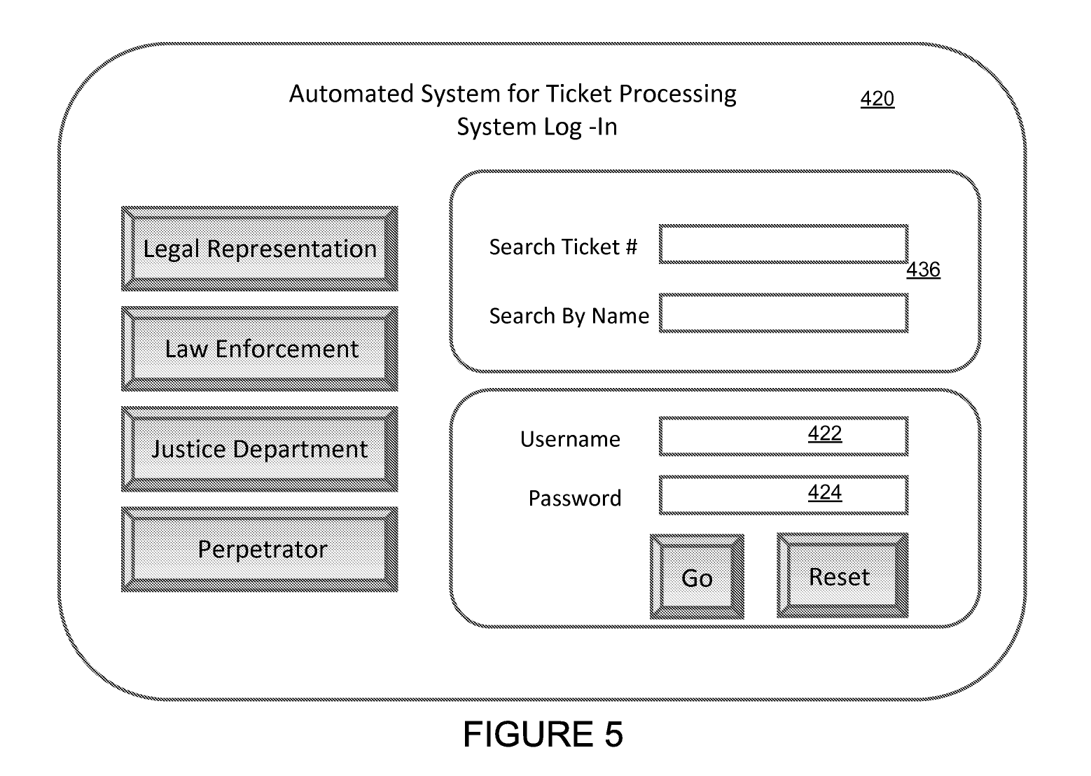

As shown in FIG. 3, an Internet web site (or sites) provides a portal 100 for the perpetrator, law enforcement, legal representatives and justice department officials to access the uploaded event information as well as process and close the case. The perpetrator can log on to the site 420 (see FIG. 5), authenticate identity (such as by entering a username 422 and password 424), search for and view the ticket information 426, make a guilty or innocent plea and pay for the ticket if guilty 130. Using real time communications for audio and video, this web portal may become a forum to replace the need for personal appearances in court. The police or other law enforcement personnel can log on and annotate evidence or provide testimony 140. A judge, justice representatives, and legal representatives can log on and review the data with special privileges 150, 160. The perpetrator or his or her attorney can log on and make a plea or add information to support his/her plea, or take similar actions. Ultimately, with secure financial transaction processing, the web portal provides a method for the perpetrator to make payment of the ticket and the funds be automatically transferred to the account of the state or local authority's receiving agency.

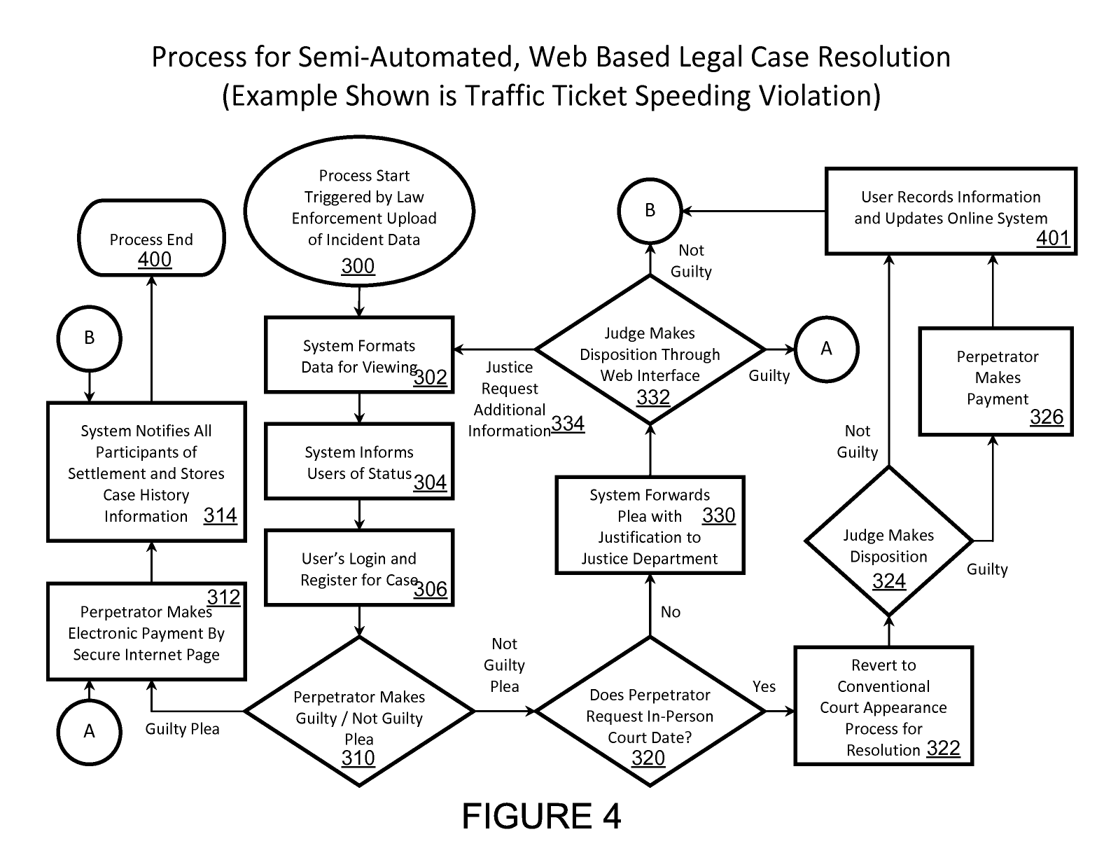

FIG. 4 outlines an exemplary embodiment of a semi-automated, web-based legal case resolution process for a traffic ticket speeding violation. The process is started by the law officer's uploading of the incident data 300. The system formats the data for viewing 302, and informs relevant users of the status of the case 304. Users can then login and register for the particular case 306. Typically, the perpetrator makes an initial guilty or not guilty plea 310. If a guilty plea is made, electronic payment of the fine or penalty is made via a secure web page 312, and the system notifies all participants of the settlement and stores all case history information 314 to terminate the process 400.

If the perpetrator makes a not guilty plea, then a determination is made whether the perpetrator requests an in-person court date 320. In some systems, entering a not guilty plea may automatically require the setting of a court date for a hearing. If a court date is set, the system reverts to the conventional court appearance process for resolution 322, i.e., a hearing is held, the judge rules on the matter 324, and the perpetrator makes payment if found guilty 326. A justice department user then records the disposition data and updates the system online 402. The system notifies all participants of the resolution of the case and stores all case history information 314 to terminate the process 400.

If no court hearing data is requested, the perpetrator is prompted to input a justification or excuse or reason for the not guilty plea. The system forwards the not guilty plea with the justification/excuse/reason to the justice department for consideration 330. The judge can make a determination of guilty or not guilty through a web-based interface 332, or can request additional information from the system or relevant users (e.g., additional information from the perpetrator, law officer, or the like) 334. If the judge makes a ruling of guilty, electronic payment of the fine or penalty is made by the perpetrator via a secure web page 312, and the system notifies all participants of the settlement and stores all case history information 314 to terminate the process 400. If the judge makes a finding of not guilty, the system notifies all participants of the resolution of the case and stores all case history information 314 to terminate the process 400.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, routines, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media and may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

It should be understood that the embodiments and examples described herein have been chosen and described in order to best illustrate the principles, methods, and processes of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A computer-based method for the processing of traffic violation data, comprising the steps of:
uploading of traffic violation data to a network database;
providing access to said data by law enforcement or justice department officials;
processing in a computer memory said data in response to input received from said law enforcement or justice department officials or legal representatives;
providing access to said data and the results of the processing to the traffic violator or perpetrator or a legal representative of said traffic violator; and
processing in a computer memory said data in response to input received from said traffic violator/perpetrator or legal representative;
wherein said data includes but is not limited to vehicle speed data, event video and/or still frame camera data including or not including audio, vehicle license plate information, vehicle driver identification and associated data, date, time, global positioning system location data and police related data.

2. The method of claim 1, wherein the uploaded event information is stored on an Internet accessible database and may be accessed through a web page or secure web portal.

3. The method of claim 1, wherein the uploaded event information is able to be viewed over the Internet and additional relevant data added, subtracted or updated as needed by the perpetrator, law enforcement officials, justice department officials or legal representatives.

4. The method of claim 1, wherein a software program controls the storage of event data, network access to the data including write and read data privileges, as well as automated notifications to the perpetrator, law enforcement officials, justice department officials and authorized individuals associated with legal representation.

5. The method of claim 1, wherein the data and software program controls are used by the perpetrator to make comment, provide a guilty or not guilty plea online, and make associated financial payments as necessary to state or local authorities online via the Internet.

6. The method of claim 1, wherein the data and software controls are used by the law enforcement officials to make comment on the case, provide testimony or otherwise assist in prosecution and resolution of the case by the perpetrator and the justice department.

7. The method of claim 1, wherein the data and software controls are used by justice department officials to review the case and if necessary make a ruling in the matter.

8. The method of claim 1, wherein the data and software controls are used by associated legal representatives such as lawyers representing one or more parties to review the case and if necessary provide legal updates, comments and pleas.

9. A computer-based method for generating and resolving traffic violation tickets, comprising the steps of:
using a speed detection device to determine and record a traffic violation by a driver of a vehicle;
uploading traffic violation event data to a database in electronic communication with at least one network server with a computer processor, said processor programmed to receive a plea from the driver of the vehicle, receive evidence submitted by law enforcement authorities, and receive a disposition of the traffic violation by a judge or judiciary representative.

10. The method of claim 9, wherein the traffic violation is violation of a speed limit.

11. The method of claim 10, wherein the speed detection device is a radar or laser speed detection gun.

12. The method of claim 11, wherein the speed detection device can access a wireless data network.

13. The method of claim 11, wherein the speed detection device has a video or still frame camera, or both, to record a picture or video of the incident.

14. The method of claim 11, wherein the speed detection device has a GPS system.

15. The method of claim 11, wherein the speed detection device can scan the vehicle driver's license or identification card.
